(19) United States
(12) Patent Application Publication
(10) Pub. No.: US 2015/0264941 A1
(43) Pub. Date: Sep. 24, 2015

(54) SHAVING CUTTER

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: NING-BO XUE, Shenzhen (CN)

(21) Appl. No.: 14/661,168

(22) Filed: Mar. 18, 2015

(30) Foreign Application Priority Data
Mar. 19, 2014 (CN) 201410102172.X

(51) Int. Cl. A21C 11/10

(52) U.S. Cl. CPC A21C 11/106

(57) ABSTRACT

A shaving cutter includes a handle; a head coupled to the handle and at least one groove. The head includes an upper surface; a bottom surface opposite the upper surface and substantially parallel to the upper surface; a first sidewall coupling the upper surface to the bottom surface; and a second sidewall opposite the first sidewall and further coupling the upper surface to the bottom surface. Each groove is protruded from the upper surface, and extends from the upper surface to the second sidewall slantwise and crookedly, and protrudes out from the second sidewall, and further forms a blade on one end of the groove distal from the first sidewall. One part of each groove close to the first sidewall is a cutter back, and the other part of each groove away from the first sidewall is a cutter groove.

### FIELD

The subject matter herein relates to shaving cutters, and particularly relates to a shaving cutter with many blades.

### BACKGROUND

Shaved noodles are a popular dish. To create shaved noodles, the flour and the water can be mixed with a certain proportion to form a dough, and the dough can be shaved to a number of leaves by using a shaving cutter. Then the number of leaves can be threw out to a pot to cook. The shaving cutter is a key factor in creating shaved noodles.

In recent years, many machines with shaving cutters are launched on the market. The current machines with shaving cutters have the following disadvantages: first, the leaves cannot easily drop into the pot in the form of parabola, and second, each shaving cutter can have only one blade, which results a low efficiency.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an isometric view of a first embodiment of a shaving cutter.

FIG. 2 is a cross sectional view of the shaving cutter shown in FIG. 1 taken along line II-II.

FIG. 3 is an isometric view of a second embodiment of a shaving cutter.

FIG. 4 is an isometric view of a third embodiment of a shaving cutter.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected.

The term “comprising,” when utilized, means “including, but not necessarily limited to”; it specifically indicates open-ended inclusion or membership in the so-described combination, group, series and the like.

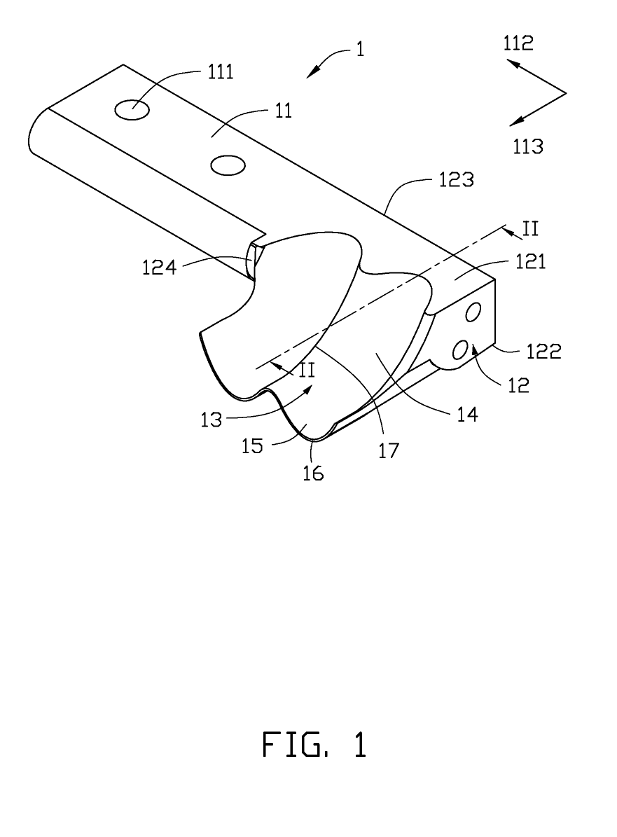

FIG. 1 shows a shaving cutter 1. The shaving cutter 1 can include a handle 11 and a head 12 located on one end of the handle 11. In this embodiment, the handle 11 and the head 12 can be made of same material. In at least one embodiment, the handle 11 and the head 12 can be separate with each other, and further coupled with each other by at least one connector such as at least one screw.

The handle 11 can define at least one mounting hole 111 thereon. Each mounting hole 111 can be used for a connector such as a screw passing through so as to couple the handle 11 with a shaving robot (not shown). In at least one embodiment, the handle 11 can be grasped to the shaving robot by a grasping member, and the at least mounting hole 111 and the at least connector can be omitted accordingly.

The head 12 can include an upper surface 121, a bottom surface 122 opposite the upper surface 121 and substantially parallel to the upper surface 121, a first sidewall 123 coupling the upper surface 121 to the bottom surface 122, and a second sidewall 124 opposite the first sidewall 123 and further coupling the upper surface 121 to the bottom surface 122.

The shaving cutter 1 can further include at least one groove 13 arranged along a length direction 112 of the handle 11. Each groove 13 can be on the upper surface 121, protruded from the upper surface 121, and extend from the upper surface 121 to the second sidewall 124 slantwise and crookedly, and further protrude out from the second sidewall 124 to a predefined distance. In this embodiment, the number of the at least one groove 13 can be two, and the two grooves 13 can have same shape and size, and the cross-section shape of the groove 13 along a direction 113 parallel to the upper surface 121 and perpendicular to the length direction 112 of the handle 11 can be arc-shaped.

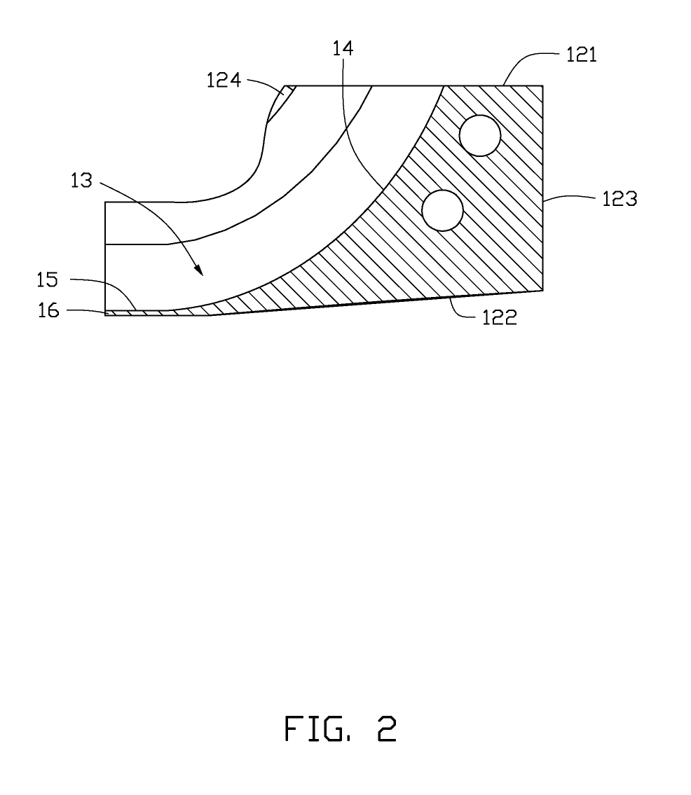

Each groove 13 can include two parts. One part of the groove 13 close to the first sidewall 123 can be a cutter back 14, and the other part of the groove 13 away from the first sidewall 123 can be a cutter groove 15. Referring to FIG. 2, the cross-section shape of the cutter back 14 along the direction 113 can be arc-shaped, and the cross-section shape of the cutter groove 15 along the direction 113 can be straight-shaped, and the cutter groove 15 can be parallel to the bottom surface 122, and further tangent to the cutter back 14.

Referring to FIGS. 1 and 2, each groove 13 can include a blade 16 formed on one end of the groove 13 distal from the first sidewall 123.

The shaving cutter 1 can further include at least one connecting portion 17. Each connecting portion 17 can be formed on two adjacent grooves 13.

When in use, the number of blades 16 can be pushed to cut into a dough (not shown), and a number of leaves can be then cut from the dough by the number of blades 16 and formed to predefined shapes with the help of the cutter groove 15, and then slide to the cutter back 14, and further fly into the pot in the form of parabola with the guide of the cutter groove 15. As the cutter backs 14 are arc-shaped, the cutter backs 14 can easily guide the leaves.

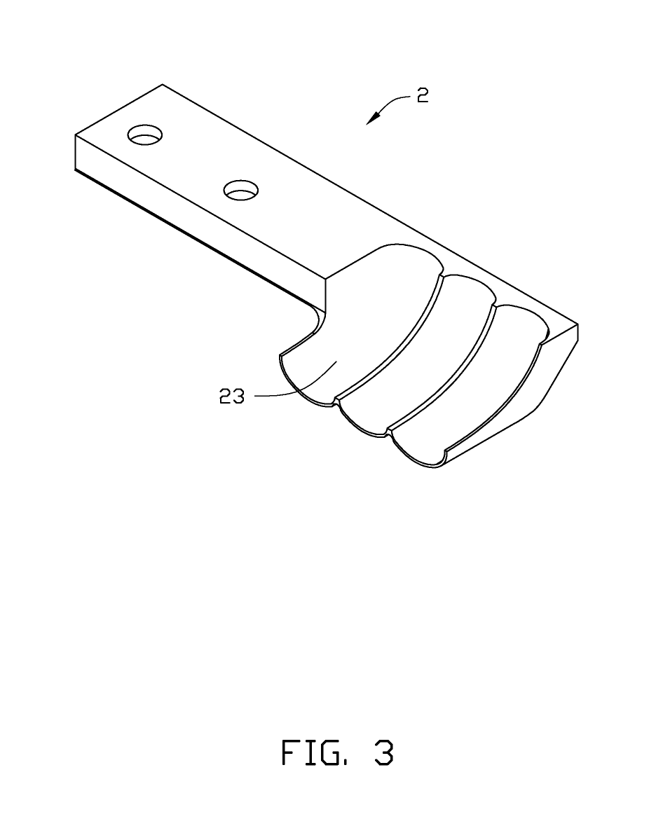

FIG. 3 shows a shaving cutter 2. The shaving cutter 2 has three grooves 23, and the three grooves 23 have the same shape and size.

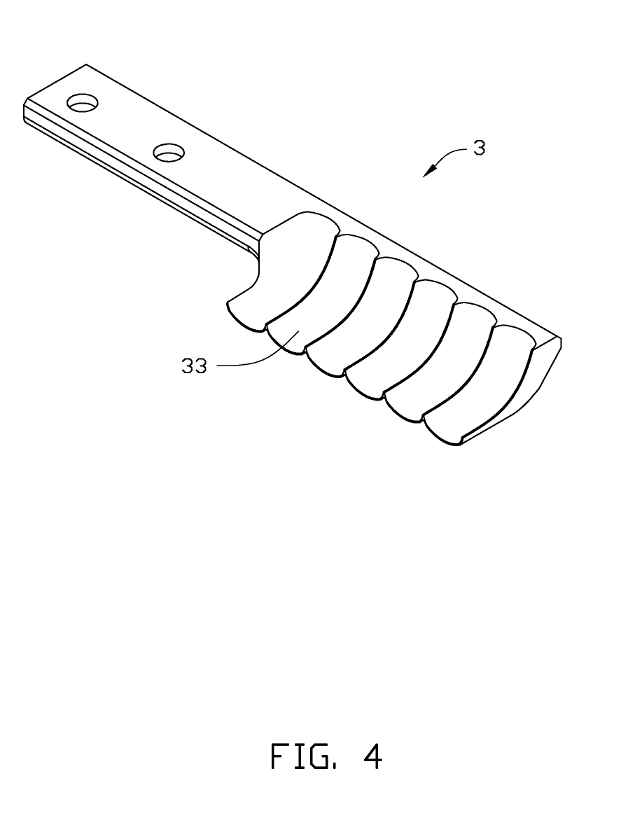

FIG. 4 shows a shaving cutter 3. The shaving cutter 3 has six grooves 33, and the six grooves 33 have the same shape and size.

In at least one embodiment, the number of the grooves can be defined according to the need.

In at least one embodiment, the shape and the size of the groove 13, 23, 33 can be different.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A shaving cutter comprising:
a handle;
a head coupled to the handle and comprising
an upper surface;
a bottom surface opposite and substantially parallel to the upper surface;
a first sidewall coupling the upper surface to the bottom surface; and
a second sidewall opposite the first sidewall and further coupling the upper surface to the bottom surface; and
at least one groove on the upper surface protruding from the second sidewall and extending from the upper surface to the second sidewall slantwise and crookedly, forming a blade on an end of the groove distal from the first sidewall, and one part of each groove close to the first sidewall is a cutter back, and the other part of each groove away from the first sidewall is a cutter groove.

2. The shaving cutter of claim 1, wherein the handle and the head are made of same material.

3. The shaving cutter of claim 1, wherein the at least one groove has same shape and size.

4. The shaving cutter of claim 3, wherein a cross-section shape of the groove along a direction parallel to the upper surface and perpendicular to a length direction of the handle is arc-shaped.

5. The shaving cutter of claim 4, wherein a cross-section shape of the cutter back along the direction is arc-shaped, and a cross-section shape of the cutter groove along the direction is straight-shaped, and the cutter groove is parallel to the bottom surface, and further tangent to the cutter back.

6. The shaving cutter of claim 3, wherein the at least one groove are arranged along a length direction of the handle, and the shaving cutter further comprises at least one connecting portion, and each connecting portion is formed on two adjacent grooves.

7. The shaving cutter of claim 1, wherein the handle defines at least one mounting hole thereon, and the at least one mounting hole is configured to couple the handle with a shaving robot.
